(19) United States
(12) Patent Application Publication
(10) Pub. No.: US 2015/0378301 A1
(43) Pub. Date: Dec. 31, 2015

(54) IMAGE FORMING DEVICE

(71) Applicant: FUJIFILM CORPORATION, Tokyo (JP)

(72) Inventor: Takayuki NAKAMURA, Kanagawa (JP)

(21) Appl. No.: 14/846,835

(22) Filed: Sep. 7, 2015

Related U.S. Application Data
(63) Continuation of application No. PCT/JP2014/051994, filed on Jan. 29, 2014.

(30) Foreign Application Priority Data
Mar. 12, 2013 (JP) 2013-049243

(51) Int. Cl. G03G 15/00

(52) U.S. Cl. CPC G03G 15/70

(57) ABSTRACT

The present invention provides an image forming device comprising: a conveying member that conveys recording media; a first sensor that is provided at a first detection position, and that detects absence or presence of a recording medium; a second sensor that is provided at a second detection position; a plurality of sensor dogs that are provided at a rotating/supporting member that drives the conveying member; a timing sensor that detects passage of the sensor dogs and determines detection timings of the first sensor and the second sensor; and a judging device that judges that there is a jam when a recording medium is continuously detected at the first sensor or the second sensor, and that judges that there is a jam when there is inconsistency in information relating to the absence or presence of a recording medium from the first sensor and the second sensor.

### CROSS-REFERENCE TO RELATED APPLICATION

This application is a continuation application of international Application No. PCT/JP2014/051994, filed Jan. 29, 2014, which is based upon and claims the benefit of priority of Japanese Patent Application No. 2013-049243, filed on Mar. 12, 2013. The entire contents of these applications are incorporated herein by reference.

### FIELD

The present invention relates to an image forming device.

### BACKGROUND

A structure provided with a first detection sensor that is disposed at a position facing an intermediate conveying drum that is at a sheet conveying direction upstream side of a drying drum, and a second detection sensor that is disposed at a position facing an intermediate conveying drum that is at a sheet conveying direction downstream side of the drying drum, is disclosed in Patent Document 1 (Japanese Patent Application Laid-Open (JP-A) No. 2012-213895). In this structure, the absence or presence of a sheet, whose leading end is grasped by a chuck, is detected by the first detection sensor and the second detection sensor, and a jam is detected when there is inconsistency between the signals detected by the first detection sensor and the second detection sensor.

However, in the system disclosed in Patent Document 1 (JP-A No. 2012-213895), when dropping-off of the sheet occurs directly beneath the first detection sensor or the second detection sensor, this is not recognized as an abnormality during the time until the chuck, that grasps the leading end of the sheet, moves from the first detection sensor to the second detection sensor in order to detect this. Therefore, time is required until a jam is detected.

In consideration of the aforementioned, a subject of the present invention is to provide an image forming device that can detect a jam more rapidly.

### SUMMARY

An image forming device of a first aspect of the present invention comprises: a conveying member that successively conveys recording media; a first sensor that is provided at a first detection position, which is at a conveying direction upstream side of the recording media that is conveyed by the conveying member, and that detects absence or presence of a recording medium; a second sensor that is provided at a second detection position, which is further toward a conveying direction downstream side of the recording media than the first detection position, and that detects absence or presence of a recording medium; a plurality of sensor dogs that are provided at a rotating/supporting member that drives the conveying member, and that are disposed so as to correspond to positions of alternately detecting a region at which there is a recording medium at the conveying member and a region at which there is no recording medium; a timing sensor that detects passage of the sensor dogs and determines detection timings of the first sensor and the second sensor; and a judging device that judges that there is a jam when a recording medium is continuously detected at the first sensor or the second sensor, and that judges that there is a jam when there is inconsistency in information relating to the absence or presence of a recording medium from the first sensor and the second sensor.

In accordance with the image forming device of the first aspect of the present invention, the plural sensor dogs, that are disposed so as to correspond to positions of alternately detecting a region at which there is a recording medium at the conveying member and a region at which there is no recording medium, are provided at the rotating/supporting member that drives the conveying member. Further, the timing sensor detects passage of the sensor dogs, and determines the detection timings of the first sensor, that is provided at the first detection position that is at a conveying direction upstream side of the recording media, and the second sensor that is provided at the second detection position that is further toward the conveying direction downstream side of the recording media than the first detection position. The recording media are successively conveyed by the conveying member, and the absence or presence of a recording medium is detected by the first sensor at timings of alternately detecting a region at which there is a recording medium at the conveying member and a region at which there is no recording medium. Moreover, the absence or presence of a recording medium is detected by the second sensor, that is further toward the conveying direction downstream side of the recording media than the first sensor, at timings of alternately detecting a region at which there is a recording medium at the conveying member and a region at which there is no recording medium. At this time, in a state of normal operation, the presence of and the absence of a recording medium are detected alternately. On the other hand, in a case in which a recording medium drops-off directly beneath the first sensor or the second sensor, due to the presence of a recording medium being detected continuously at the first sensor or the second sensor, it is judged by the judging device that there is a jam. Therefore, in a case in which a recording medium drops-off directly beneath the first sensor or the second sensor, the abnormality can be detected rapidly. Further, in a case in which a recording medium does not drop-off directly beneath the first sensor or the second sensor but drops-off between the first sensor and the second sensor, it is judged that there is a jam due to the inconsistency between the information relating to the absence or presence of a recording medium from the first sensor and the second sensor. At this time, because the absence or presence of a recording medium is being detected alternately at the first sensor, a recording medium is being conveyed normally at least by an amount corresponding to the length of the recording medium from the first sensor, and the distance to the second sensor, that is the region at which the dropping-off of a recording medium has occurred, is shorter. Therefore, the jam can be detected more rapidly.

In an image forming device of a second aspect of the present invention, in the image forming device of the first aspect, the conveying member is a chain gripper that grasps and conveys end portions of the recording media, the rotating/supporting member is a sprocket that moves the chain gripper, and the timing sensor is provided at a position that faces the sprocket and that is synchronous with a distance between grippers of the chain gripper.

In accordance with the image forming device of the second aspect of the present invention, the chain gripper is moved by rotation of the sprocket, and end portions of recording media are grasped and conveyed by the chain gripper. The timing sensor is provided at a position that faces the sprocket and that is synchronous with the distance between grippers of the chain gripper. The timing sensor causes the first sensor and the second sensor to detect the absence or presence of a recording medium at timings of alternately detecting a region at which there is a recording medium at the chain gripper and a region at which there is no recording medium. Due thereto, the absence or presence of recording media that are actually being conveyed are detected alternately by the first sensor and the second sensor, and therefore, a jam can be detected more rapidly.

In an image forming device of a third aspect of the present invention, in the image forming device of the first aspect, the conveying member successively conveys the recording media to a drying/fixing section that dries and fixes liquid drops that have been ejected onto the recording media, and the first sensor is disposed at an entrance of the drying/fixing section, and the second sensor is disposed at an exit of the drying/fixing section.

In accordance with the image forming device of the third aspect of the present invention, the recording media are successively conveyed to the drying/fixing section that dries and fixes liquid drops that have been ejected onto the recording media. Further, the absence or presence of a recording medium is detected by the first sensor that is disposed at the entrance of the drying/fixing section, and the absence or presence of a recording medium is detected by the second sensor that is disposed at the exit of the drying/fixing section. Due thereto, a jam can be detected more rapidly even in cases in which a recording medium drops-off directly beneath the entrance of and the exit of the drying/fixing section and between the entrance and the exit of the drying/fixing section.

In an image forming device of a fourth aspect of the present invention, the image forming device of the third aspect comprises a printing drum that conveys the recording media, and at which the liquid drops are ejected onto the recording media from liquid drop ejection heads, wherein the rotating/supporting member rotates at a same cycle as the printing drum, and the plurality of sensor dogs are provided at positions at the rotating/supporting member, which positions correspond to regions of holding the recording media at the printing drum and regions between the recording media.

In accordance with the image forming device of the fourth aspect of the present invention, recording media are conveyed by the printing drum, and liquid drops are ejected onto the recording media from liquid drop ejecting heads. The rotating/supporting member rotates at the same cycle as the printing drum, and the plural sensor dogs are provided at positions of the rotating/supporting member, which positions correspond to regions of holding a recording medium on the printing drum and regions between the recording media. Due thereto, it is easy to place the plural sensor dogs, and the timing sensor that detects the passage of the sensor dogs.

In an image forming device of a fifth aspect of the present invention, in the image forming device of the third aspect, a heat source of the drying/fixing section is stopped in a case in which it is judged by the judging device that there is a jam.

In accordance with the image forming device of the fifth aspect of the present invention, the heat source of the drying/fixing section is stopped when it is judged by the judging device that there is a jam. Therefore, the recording medium becoming high temperature can be suppressed.

In accordance with the image forming device relating to the present invention, a jam can be detected more rapidly.

### BRIEF DESCRIPTION OF DRAWINGS

FIG. 1 is a front view showing an image forming device relating to a first embodiment of the present invention.

FIG. 2 is a block diagram of a control system of a jam detecting device that is used in the image forming device shown in FIG. 1.

FIG. 3 is an enlarged front view showing a process of alternately detecting a region at which there is a sheet and a region at which there is no sheet, of a chain gripper at a first sensor of the jam detecting device.

FIG. 4 is an enlarged front view showing the process of alternately detecting a region at which there is a sheet and a region at which there is no sheet, of the chain gripper at the first sensor of the jam detecting device.

FIG. 5 is an enlarged front view showing a process of alternately detecting a region at which there is a sheet and a region at which there is no sheet, of the chain gripper at a second sensor of the jam detecting device.

FIG. 6 is an enlarged front view showing the process of alternately detecting a region at which there is a sheet and a region at which there is no sheet, of the chain gripper at the second sensor of the jam detecting device.

FIG. 7 is an enlarged front view showing a state in which a sheet has dropped-off directly beneath the second sensor of the jam detecting device.

FIG. 8 is an enlarged front view showing a state in which a sheet has dropped-off between the first sensor and the second sensor of the jam detecting device.

FIG. 9 is a timing chart at a time of normal operation at the jam detecting device.

FIG. 10 is a timing chart in a case in which a sheet has dropped-off directly beneath the second sensor at the jam detecting device.

FIG. 11 is a timing chart in a case in which a sheet has dropped-off between the first sensor and the second sensor at the jam detecting device.

### DESCRIPTION OF EMBODIMENTS

An example of an embodiment relating to the present invention is described hereinafter with reference to the drawings.

<<Device Structure>>

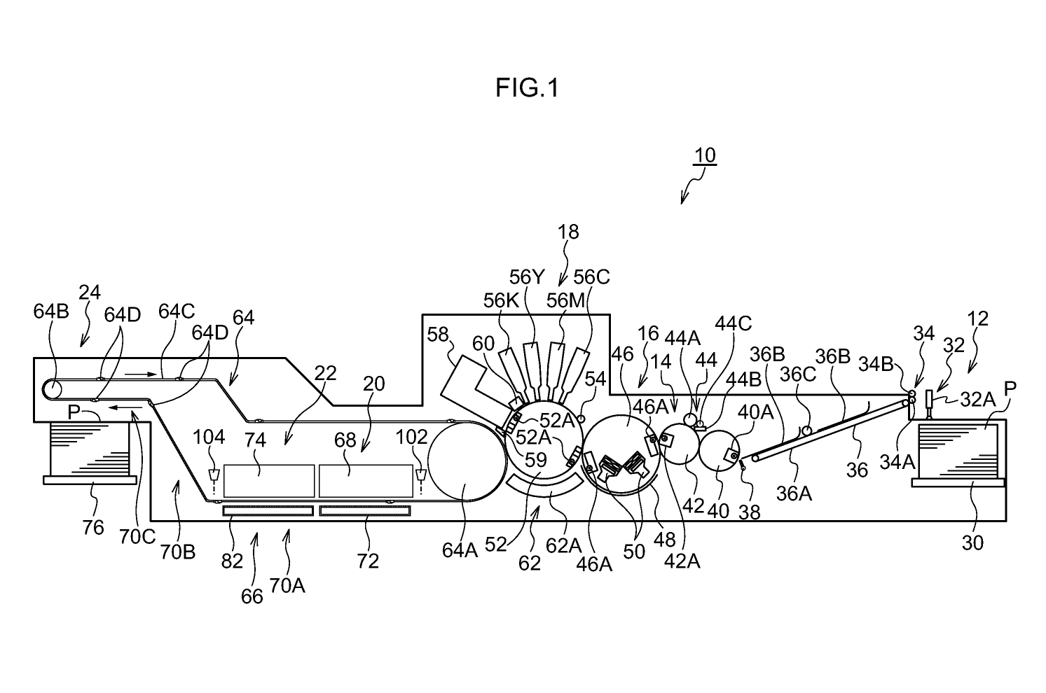

FIG. 1 is an overall structural drawing showing a first embodiment of an inkjet recording device that serves as an image forming device relating to the present invention.

An inkjet recording device 10 of the present embodiment is a device that records images by an inkjet method and by using aqueous UV inks (UV (ultraviolet ray) curable inks that use an aqueous medium) on sheet-like sheets (recording media) P. This inkjet recording device 10 mainly has a sheet feeding section 12 that feeds the sheets P, a processing liquid applying section 14 that applies a predetermined processing liquid to the obverse (image recording surface) of the sheet P that has been fed from the sheet feeding section 12, a processing liquid drying processing section 16 that carries out drying processing of the sheet P onto which the processing liquid has been applied at the processing liquid applying section 14, an image recording section 18 that records an image by an inkjet method and by using aqueous UV inks onto the obverse of the sheet P that has been subjected to drying processing at the processing liquid drying processing section 16, an ink drying processing section 20 that serves as an example of a drying/fixing section and that carries out drying processing of the sheet P on which an image has been recorded at the image recording section 18, a UV irradiating processing section 22 that serves as an example of the drying/fixing section and that carries out UV irradiating processing (fixing processing) on the sheet P that has been subjected to drying processing at the ink drying processing section 20 and fixes the image, and a sheet discharging section 24 that discharges the sheet P that has been subjected to UV irradiating processing at the UV irradiating processing section 22.

<Sheet Feeding Section>

The sheet feeding section 12 feeds the sheets P, that are stacked on a sheet feeding stand 30, one-by-one to the processing liquid applying section 14. The sheet feeding section 12 that serves as an example of a sheet feeding device is mainly structured by the sheet feeding stand 30, a sucker device 32, a sheet feeding roller pair 34, a feeder board 36, a front abutter 38, and a sheet feeding drum 40.

The sheets P are placed on the sheet feeding stand 30 in the state of a sheaf in which numerous sheets are stacked. The sheet feeding stand 30 is provided so as to be able to be raised and lowered by an unillustrated sheet feeding stand raising/lowering device. The driving of the sheet feeding stand raising/lowering device is controlled interlockingly with the increase/decrease in the sheets P that are stacked on the sheet feeding stand 30, and the sheet feeding stand raising/lowering device raises and lowers the sheet feeding stand 30 such that the sheet P, that is positioned topmost in the sheaf, is always positioned at a constant height.

The sheet P that serves as a recording medium is not particularly limited, and general printing sheets (sheets whose main component is cellulose such as so-called high-grade paper, coated paper, art paper or the like) that are used in general offset printing and the like can be used. In the present example, coating-processed paper is used. Coating-processed paper is paper in which a coating layer is provided by coating a coating agent onto the surface of high-grade paper or acid-free paper or the like that generally has not been surface treated. Concretely, art paper, coated paper, light-weight coated paper, finely coating-processed paper, and the like are suitably used.

The sucker device 32 takes-up the sheets P, that are stacked on the sheet feeding stand 30, one-by-one in order from the top, and feeds the sheets P to the sheet feeding roller pair 34. The sucker device 32 has a suction foot 32A that is provided so as to freely rise and fall and so as to swing freely. The top surface of the sheet P is sucked and held by this suction foot 32A, and the sucker device 32 moves the sheet P from the sheet feeding stand 30 to the sheet feeding roller pair 34. At this time, the suction foot 32A sucks and holds the top surface of the leading end side of the sheet P that is positioned at the topmost position of the sheaf, and pulls the sheet P up, and inserts the leading end of the pulled-up sheet P between a pair of rollers 34A, 34B that structure the sheet feeding roller pair 34.

The sheet feeding roller pair 34 is structured by the pair of upper and lower rollers 34A, 34B that are pushed to abut one another. One of the pair of upper and lower rollers 34A, 34B is made to be a driving roller (the roller 34A), and the other is made to be a driven roller (the roller 34B). The driving roller (the roller 34A) is driven by an unillustrated motor and rotates. The motor is driven interlockingly with the feeding of the sheets P. When the sheet P is fed from the sucker device 32, the motor rotates the driving roller (the roller 34A) in accordance with the timing thereof. The sheet P, that has been inserted between the pair of upper and lower rollers 34A, 34B, is nipped by these rollers 34A, 34B, and is sent-out in the rotating direction of the rollers 34A, 34B (the direction in which the feeder board 36 is set).

The feeder board 36 is formed so as to correspond to the sheet width, and receives the sheet P that is sent-out from the sheet feeding roller pair 34, and guides the sheet P to as far as the front abutter 38. This feeder board 36 is set so as to be inclined downward, and causes the sheet P that has been placed on the conveying surface thereof to slide along the conveying surface, and guides the sheet P to as far as the front abutter 38.

Plural tape feeders 36A for conveying the sheet P are set at the feeder board 36 at intervals in the transverse direction. The tape feeders 36A are formed in endless forms, and are driven by an unillustrated motor and rotate. Movement is imparted by these tape feeders 36A to the sheet P that has been placed on the conveying surface of the feeder board 36, and the sheet P is conveyed on the feeder board 36.

Further, retainers 36B and a roller 36C are set above the feeder board 36. The plural (two in the present example) retainers 36B are disposed so as to be lined-up lengthwise front and rear along the conveying surface of the sheet P. The retainers 36B are structured by plate springs that have widths corresponding to the sheet width, and are set so as to be pushed against and abut the conveying surface. The convexity and concavity of the sheet P, that is conveyed on the feeder board 36 by the tape feeders 36A, are corrected due to the sheet P passing by these retainers 36B. Note that the rear end portions of the retainers 36B are formed so as to be curled in order to easily introduce the sheet P in between the retainers 36B and the feeder board 36.

The roller 36C is disposed between the front and rear retainers 36B. This roller 36C is set so as to be pushed and abutted against the conveying surface of the sheet P. The sheet P, that is conveyed between the front and rear retainers 36B, is conveyed while the top surface thereof is held down by the roller 36C.

The front abutter 38 corrects the posture of the sheet P. This front abutter 38 is formed in a plate shape, and is disposed orthogonal to the conveying direction of the sheet P. Further, the front abutter 38 is driven by an unillustrated motor, and is provided so as to be swingable. The leading end of the sheet P, that was conveyed on the feeder board 36, is made to abut the front abutter 38, and the posture of the sheet P is corrected (so-called skew prevention). The front abutter 38 swings interlockingly with the feeding of the sheet to the sheet feeding drum 40, and transfers the sheet P whose posture has been corrected to the sheet feeding drum 40.

The sheet feeding drum 40 receives the sheet P that is fed from the feeder board 36 via the front abutter 38, and conveys the sheet P to the processing liquid applying section 14. The sheet feeding drum 40 is formed in a cylindrical shape, and is driven by an unillustrated motor and rotates. A gripper 40A is provided on the outer peripheral surface of the sheet feeding drum 40, and the leading end of the sheet P is grasped by this gripper 40A. Due to the sheet feeding drum 40 rotating while grasping the leading end of the sheet P by the gripper 40A, the sheet feeding drum 40 conveys the sheet P to the processing liquid applying section 14 while training the sheet P on the peripheral surface thereof.

The sheet feeding section 12 is structured as described above. The sheets P that are stacked on the sheet feeding stand 30 are pulled-up one-by-one in order from the top by the sucker device 32, and are fed to the sheet feeding roller pair 34. The sheet P that has been fed to the sheet feeding roller pair 34 is sent-out forward by the pair of upper and lower rollers 34A, 34B that structure this sheet feeding roller pair 34, and is placed on the feeder board 36. The sheet P that has been placed on the feeder board 36 is conveyed by the tape feeders 36A that are provided at the conveying surface of the feeder board 36. Then, in this conveying process, the sheet P is pushed against the conveying surface of the feeder board 36 by the retainers 36B, and the convexity and concavity of the sheet P are corrected. Due to the leading end of the sheet P that has been conveyed by the feeder board 36 being made to abut the front abutter 38, tilting is corrected, and thereafter, the sheet P is transferred to the sheet feeding drum 40. Then, the sheet P is conveyed to the processing liquid applying section 14 by this sheet feeding drum 40.

<Processing Liquid Applying Section>

The processing liquid applying section 14 applies a predetermined processing liquid to the obverse (the image recording surface) of the sheet P. This processing liquid applying section 14 is structured mainly by a processing liquid applying drum 42 that conveys the sheet P, and a processing liquid applying unit 44 that applies the predetermined processing liquid to the printing surface of the sheet P conveyed by the processing liquid applying drum 42.

The processing liquid applying drum 42 receives the sheet P from the sheet feeding drum 40 of the sheet feeding section 12, and conveys the sheet P to the processing liquid drying processing section 16. The processing liquid applying drum 42 is formed in a cylindrical shape, and is driven by an unillustrated motor and rotates. A gripper 42A is provided on the outer peripheral surface of the processing liquid applying drum 42, and the leading end of the sheet P is grasped by this gripper 42A. Due to the processing liquid applying drum 42 rotating while grasping the leading end of the sheet P by this gripper 42A, the processing liquid applying drum 42 conveys the sheet P to the processing liquid drying processing section 16 while training the sheet P on the peripheral surface thereof (conveys the one sheet P by one rotation). The rotating of the processing liquid applying drum 42 and the sheet feeding drum 40 are controlled such that the timings of the receiving and the transferring of the sheet P to and from one another match. Namely, the processing liquid applying drum 42 and the sheet feeding drum 40 are driven so as to become the same peripheral speed, and are driven such that the positions of the grippers thereof match.

The processing liquid applying unit 44 coats, by a roller, the processing liquid onto the obverse of the sheet P conveyed by the processing liquid applying drum 42. This processing liquid applying unit 44 is structured mainly by a coating roller 44A that coats the processing liquid onto the sheet P, a processing liquid tank 44B in which the processing liquid is stored, and a draw-up roller 44C that draws-up the processing liquid stored in the processing liquid tank 44B and supplies the processing liquid to the coating roller 44A. The draw-up roller 44C is set so as to press and abut the coating roller 44A, and is set such that a portion of the draw-up roller 44C is submerged in the processing liquid that is stored in the processing liquid tank 44B. This draw-up roller 44C measures-out and draws-up the processing liquid, and applies the processing liquid at a uniform thickness onto the peripheral surface of the coating roller 44A. The coating roller 44A is provided so as to correspond to the sheet width, and is pressed and abutted against the sheet P, and coats the processing liquid, that has been applied on the peripheral surface thereof, onto the sheet P. The coating roller 44A is driven by an unillustrated abutting/separating mechanism, and moves between an abutting position of abutting the peripheral surface of the processing liquid applying drum 42, and a separated position of being separated from the peripheral surface of the processing liquid applying drum 42. The abutting/separating mechanism moves the coating roller 44A in accordance with the timing of the passage of the sheet P, and coats the processing liquid onto the obverse of the sheet P that is conveyed by the processing liquid applying drum 42.

Note that the present example is structured so as to coat the processing liquid by a roller, but the method of applying the processing liquid is not limited to this. Other than this, a structure that applies the processing liquid by using an inkjet head or a structure that applies the processing liquid by spraying can also be employed.

The processing liquid applying section 14 is structured as described above. The sheet P, that has been transferred from the sheet feeding drum 40 of the sheet feeding section 12, is received at the processing liquid applying drum 42. Due to the processing liquid applying drum 42 grasping the leading end of the sheet P by the gripper 42A and rotating, the processing liquid applying drum 42 trains the sheet P around the peripheral surface thereof and conveys the sheet P. In this conveying process, the coating roller 44A is pressed and abutted against the obverse of the sheet P, and the processing liquid is coated on the obverse of the sheet P.

Here, as the processing liquid that is coated on the obverse of this sheet P, a processing liquid, that has the function of agglomerating the color materials within the aqueous UV inks that are ejected onto the sheet P at the image recording section 18 that is a later stage, is coated. By coating such a processing liquid onto the obverse of the sheet P and ejecting drops of the aqueous UV inks thereon, high quality printing can be carried out without causing drop impact interference or the like, even when using general printing sheets.

<Processing Liquid Drying Processing Section>

The processing liquid drying processing section 16 carries out drying processing on the sheet P to whose obverse the processing liquid has been applied. This processing liquid drying processing section 16 is mainly structured by a processing liquid drying processing drum 46 that conveys the sheet P, a sheet conveying guide 48, and processing liquid drying processing units 50 that blow hot air out onto the printing surface of the sheet P conveyed by the processing liquid drying processing drum 46, and dry the printing surface.

The processing liquid drying processing drum 46 receives the sheet P from the processing liquid applying drum 42 of the processing liquid applying section 14, and conveys the sheet P to the image recording section 18. The processing liquid drying processing drum 46 is structured by a frame body that is built in a cylindrical shape, and is driven by an unillustrated motor and rotates. Grippers 46A are provided on the outer peripheral surface of the processing liquid drying processing drum 46, and the leading end of the sheet P is grasped by the gripper 46A. Due to the processing liquid drying processing drum 46 rotating while grasping the leading end of the sheet P by this gripper 46A, the processing liquid drying processing drum 46 conveys the sheet P to the image recording section 18. Note that the processing liquid drying processing drum 46 of the present example is structured such that the grippers 46A are disposed at two places on the outer peripheral surface, and two of the sheets P can be conveyed by one rotation. The rotating of the processing liquid drying processing drum 46 and the processing liquid applying drum 42 are controlled such that the timings of the receiving and the transferring of the sheet P to and from one another match. Namely, the processing liquid drying processing drum 46 and the processing liquid applying drum 42 are driven so as to become the same peripheral speed, and are driven such that the positions of the grippers thereof match.

The sheet conveying guide 48 is disposed along the conveying path of the sheet P by the processing liquid drying processing drum 46, and guides the conveying of the sheet P.

The processing liquid drying processing units 50 are disposed at the inner side of the processing liquid drying processing drum 46, and blow hot air out toward the obverse of the sheet P conveyed by the processing liquid drying processing drum 46, and carry out drying processing. In the present example, the two processing liquid drying processing units 50 are disposed within the processing liquid drying processing drum, and are structured to blow hot air out toward the obverse of the sheet P conveyed by the processing liquid drying processing drum 46.

The processing liquid drying processing section 16 is structured as described above. The sheet P, that has been transferred from the processing liquid applying drum 42 of the processing liquid applying section 14, is received at the processing liquid drying processing drum 46. The processing liquid drying processing drum 46 conveys the sheet P by grasping the leading end of the sheet P by the gripper 46A and rotating. At this time, the processing liquid drying processing drum 46 conveys the sheet P with the obverse of the sheet P (the surface on which the processing liquid was coated) facing toward the inner side. In the process of the sheet P being conveyed by the processing liquid drying processing drum 46, hot air is blown-out from the processing liquid drying processing units 50, that are set at the inner side of the processing liquid drying processing drum 46, onto the obverse of the sheet P, and the sheet P is subjected to drying processing. Namely, the solvent component within the processing liquid is removed. Due thereto, an ink agglomerating layer is formed on the obverse of the sheet P.

<Image Recording Section>

The image recording section 18 ejects liquid drops of inks (aqueous UV inks) of the respective colors of C, M, Y, K onto the printing surface of the sheet P, and draws a color image on the printing surface of the sheet P. This image recording section 18 is structured mainly by an image recording drum 52 that serves as an example of a printing drum and that conveys the sheet P, a sheet pressing roller 54 that presses the sheet P that is conveyed by the image recording drum 52 and causes the sheet P to fit tightly to the peripheral surface of the image recording drum 52, inkjet heads 56C, 56M, 56Y, 56K that serve as examples of liquid drop ejection heads that eject ink drops of the respective colors of C, M, Y, K onto the sheet P, an inline sensor 58 that reads-out the image recorded on the sheet P, a mist filter 60 that traps ink mist, and a drum cooling unit 62.

The image recording drum 52 receives the sheet P from the processing liquid drying processing drum 46 of the processing liquid drying processing section 16, and conveys the sheet P to the ink drying processing section 20. The image recording drum 52 is formed in a cylindrical shape, and is driven by an unillustrated motor and rotates. Grippers 52A are provided on the outer peripheral surface of the image recording drum 52, and the leading end of the sheet P is grasped by the gripper 52A. Due to the image recording drum 52 grasping the leading end of the sheet P by the gripper 52A and rotating, the image recording drum 52 conveys the sheet P to the ink drying processing section 20 while training the sheet P around the peripheral surface. Further, numerous suction holes (not illustrated) are formed in a predetermined pattern in the peripheral surface of the image recording drum 52. Due to the sheet P, that is trained around the peripheral surface of the image recording drum 52, being sucked from these suction holes, the sheet P is conveyed while being sucked and held at the peripheral surface of the image recording drum 52. Due thereto, the sheet P can be conveyed with good smoothness.

Note that the suction from these suction holes is applied only in a given range, and is applied from a predetermined suction start position to a predetermined suction end position. The suction start position is set at the set position of the sheet pressing roller 54, and the suction end position is set at the downstream side of the set position of the inline sensor 58 (e.g., is set at the position where the sheet is transferred to the ink drying processing section 20). Namely, the suction holes are set such that the sheet P is sucked and held at the peripheral surface of the image recording drum 52 at least at the set positions of the inkjet heads 56C, 56M, 56Y, 56K (the image recording positions) and the set position of the inline sensor 58 (the image read-out position).

Note that the mechanism for sucking and holding the sheet P at the peripheral surface of the image recording drum 52 is not limited to the above-described suction method by negative pressure, and a method in accordance with static electricity attraction also can be employed.

Further, the image recording drum 52 of the present example is structured such that the grippers 52A are disposed at two places on the outer peripheral surface thereof, and such that two of the sheets P can be conveyed by one rotation. Rotation of the image recording drum 52 and the processing liquid drying processing drum 46 are controlled such that the timings of the transferring and the receiving of the sheet P to and from one another match. Namely, the image recording drum 52 and the processing liquid drying processing drum 46 are driven so as to become the same peripheral speed, and are driven such that the positions of the grippers thereof match.

The sheet pressing roller 54 is disposed in a vicinity of the sheet receiving position of the image recording drum 52 (the position where the sheet P is received from the processing liquid drying processing drum 46). This sheet pressing roller 54 is structured by a rubber roller, and is set so as to be pressed against and made to abut the peripheral surface of the image recording drum 52. The sheet P, that has been transferred from the processing liquid drying processing drum 46 to the image recording drum 52, is nipped by passing by this sheet pressing roller 54, and is made to fit tightly to the peripheral surface of the image recording drum 52.

The four inkjet heads 56C, 56M, 56Y, 56K are disposed at a uniform interval along the conveying path of the sheet P by the image recording drum 52. These inkjet heads 56C, 56M, 56Y, 56K are structured by line heads corresponding to the sheet width, and are disposed such that the nozzle surfaces thereof face the peripheral surface of the image recording drum 52. The respective inkjet heads 56C, 56M, 56Y, 56K record an image onto the sheet P that is conveyed by the image recording drum 52, by ejecting drops of the inks toward the image recording drum 52 from nozzle rows that are formed at the nozzle surfaces.

Note that, as described above, aqueous UV inks are used as the inks that are ejected from the respective inkjet heads 56C, 56M, 56Y, 56K. The aqueous UV inks can be cured due to ultraviolet rays (UV) being irradiated thereon after ejection.

The inline sensor 58 is set at the downstream side of the final inkjet head 56K with respect to the conveying direction of the sheet P by the image recording drum 52, and reads-out the image recorded by the inkjet heads 56C, 56M, 56Y, 56K. This inline sensor 58 is structured by, for example, a line scanner, and reads-out the image that was recorded by the inkjet heads 56C, 56M, 56Y, 56K, from the sheet P that is conveyed by the image recording drum 52.

A contact preventing plate 59 is set adjacent to the inline sensor 58 at the downstream side of the inline sensor 58. This contact preventing plate 59 prevents the sheet P from contacting the inline sensor 58 when floating-up arises at the sheet P due to problems with conveying or the like.

The mist filter 60 is disposed between the final inkjet head 56K and the inline sensor 58, and sucks air at the periphery of the image recording drum 52 and traps ink mist. By sucking air at the periphery of the image recording drum 52 and trapping ink mist in this way, penetration of ink mist into the inline sensor 58 can be prevented, and the occurrence of reading defects and the like can be prevented.

The drum cooling unit 62 blows cold air out onto the image recording drum 52, and cools the image recording drum 52. This drum cooling unit 62 is structured mainly by an air conditioner (not illustrated), and a duct 62A that blows cold air, that is supplied from the air conditioner, out onto the peripheral surface of the image recording drum 52. The duct 62A blows cold air out onto a region of the image recording drum 52 other than the conveying region of the sheet P, and cools the image recording drum 52. In the present example, because the sheet P is conveyed along the circular-arc-shaped surface of the substantially upper half of the image recording drum 52, the duct 62A is structured so as to blow cold air out onto the region at the substantially lower half of the image recording drum 52 and cool the image recording drum 52. Concretely, the blow-out port of the duct 62A is formed in a circular arc shape so as to cover the substantially lower half of the image recording drum 52, and is structured such that cold air is blown-out onto the region at the substantially lower half of the image recording drum 52.

Here, the temperature of cooling the image recording drum 52 is determined by the relationship with the temperature of the inkjet heads 56C, 56M, 56Y, 56K (the temperature of the nozzle surfaces in particular), and is cooled so as to become a temperature that is lower than the temperature of the inkjet heads 56C, 56M, 56Y, 56K. Due thereto, condensation arising at the inkjet heads 56C, 56M, 56Y, 56K can be prevented. Namely, by making the temperature of the image recording drum 52 be lower than the inkjet heads 56C, 56M, 56Y, 56K, condensation can be brought about at the image recording drum side, and condensation that arises at the inkjet heads 56C, 56M, 56Y, 56K (in particular, condensation that arises at the nozzle surfaces) can be prevented.

The image recording section 18 is structured as described above. The sheet P, that has been transferred from the processing liquid drying processing drum 46 of the processing liquid drying processing section 16, is received at the image recording drum 52. The image recording drum 52 conveys the sheet P by grasping the leading end of the sheet P by the gripper 52A and rotating. Due to the sheet P, that has been transferred to the image recording drum 52, first passing by the sheet pressing roller 54, the sheet P is made to fit tightly to the peripheral surface of the image recording drum 52. Simultaneously therewith, the sheet P is sucked from the suction holes of the image recording drum 52, and is sucked and held on the outer peripheral surface of the image recording drum 52. The sheet P is conveyed in this state, and passes by the respective inkjet heads 56C, 56M, 56Y, 56K. Then, the drops of the inks of the respective colors of C, M, Y, K are ejected onto the obverse of the sheet P from the respective inkjet heads 56C, 56M, 56Y, 56K at the time when the sheet P passes by, and a color image is drawn on the obverse of the sheet P. Because the ink agglomerating layer is formed on the obverse of the sheet P, a high-quality image can be recorded without feathering or bleeding or the like being caused.

The sheet P, on which an image has been recorded by the inkjet heads 56C, 56M, 56Y, 56K, next passes by the inline sensor 58. Then, at the time of passing by this inline sensor 58, the image that has been recorded on the obverse of the sheet P is read-out. This reading-out of the recorded image is carried out as needed, and inspection of ejection defects and the like is carried out from the read-out image. At the time of carrying out reading-out, the reading-out is carried out in the state in which the sheet P is sucked and held at the image recording drum 52, and therefore, reading-out can be carried out highly precisely. Further, because reading-out is carried out immediately after image recording, abnormalities such as, for example, ejection defects and the like can be detected immediately, and can be dealt with rapidly. Due thereto, wasteful recording can be prevented, and the generating of waste paper can be kept to a minimum.

Thereafter, the sucking of the sheet P to the image recording drum 52 is cancelled, and thereafter, the sheet P is transferred to the ink drying processing section 20.

<Ink Drying Processing Section>

The ink drying processing section 20 carries out drying processing of the sheet P after image recording, and removes the liquid component remaining on the obverse of the sheet P. The ink drying processing section 20 is mainly structured by a chain gripper 64 that serves as an example of a conveying member that conveys the sheet P on which the image has been recorded, a back tension applying mechanism (suction mechanism) 66 that applies back tension to the sheet P conveyed by the chain gripper 64, and an ink drying processing unit 68 that serves as an example of a drying section that carries out drying processing of the sheet P conveyed by the chain gripper 64.

The chain gripper 64 is a sheet conveying mechanism that is used in common at the ink drying processing section 20, the UV irradiating processing section 22 and the sheet discharging section 24, and receives the sheet P that has been transferred from the image recording section 18, and conveys the sheet P to as far as the sheet discharging section 24.

This chain gripper 64 is mainly structured by first sprockets (chain sprockets) 64A that are set adjacent to the image recording drum 52, second sprockets (chain sprockets) 64B that are set at the sheet discharging section 24, chains 64C that are endless and are trained around the first sprockets 64A and the second sprockets 64B, plural chain guides (not illustrated) that guide the traveling of the chains 64C, and plural grippers 64D that are mounted to the chains 64C at a uniform interval. The first sprockets 64A, the second sprockets 64B, the chains 64C, and the chain guides are respectively structured as pairs, and are disposed at both sides in the transverse direction of the sheet P. The grippers 64D are set so as to bridge over the chains 64C that are provided as a pair.

The first sprockets 64A are set adjacent to the image recording drum 52 such that the sheet P that has been transferred from the image recording drum 52 can be received by the gripper 64D. The first sprockets 64A are axially supported by unillustrated bearings, and are provided so as to rotate freely, and an unillustrated motor is connected thereto. The chains 64C that are trained around the first sprockets 64A and the second sprockets 64B travel due to this motor being driven.

The second sprockets 64B are set at the sheet discharging section 24 such that the sheet P that is received from the image recording drum 52 can be collected at the sheet discharging section 24. Namely, the positions at which these second sprockets 64B are set are made to be the final end of the conveying path of the sheet P by the chain gripper 64. These second sprockets 64B are axially supported by unillustrated bearings, and are provided so as to rotate freely.

The chains 64C are formed in endless forms, and are trained around the first sprockets 64A and the second sprockets 64B.

The chain guides are disposed at predetermined positions and guide the chains 64C such that the chains 64C travel on a predetermined path (=guide the chains 64C such that the sheet P travels and is conveyed on a predetermined conveying path). In the inkjet recording device 10 of the present example, the second sprockets 64B are set at a position that is higher than the first sprockets 64A. Therefore, a traveling path at which the chains 64C are inclined midway therealong is formed. Concretely, the traveling path is structured by a first horizontal conveying path 70A, an inclined conveying path 70B, and a second horizontal conveying path 70C.

The first horizontal conveying path 70A is set at the same height as the first sprockets 64A, and is set such that the chains 64C that are trained around the first sprockets 64A travel horizontally. The second horizontal conveying path 70C is set at the same height as the second sprockets 64B, and is set such that the chains 64C that are trained around the second sprockets 64B travel horizontally. The inclined conveying path 70B is set between the first horizontal conveying path 70A and the second horizontal conveying path 70C, and is set so as to connect the first horizontal conveying path 70A and the second horizontal conveying path 70C.

The chain guides are disposed so as to form the first horizontal conveying path 70A, the inclined conveying path 70B and the second horizontal conveying path 70C. Concretely, the chain guides are disposed at least at the joining point of the first horizontal conveying path 70A and the inclined conveying path 70B, and at the joining point of the inclined conveying path 70B and the second horizontal conveying path 70C.

The plural grippers 64D are mounted to the chains 64C at a uniform interval. The interval at which these grippers 64D are mounted is set so as to accord with the interval of receiving the sheets P from the image recording drum 52. Namely, the mounting interval is set so as to accord with the interval of receiving the sheets P from the image recording drum 52, such that the sheets P that are transferred successively from the image recording drum 52 can be received from the image recording drum 52 with the timings matching.

The chain gripper 64 is structured as described above. As described above, when the motor (not illustrated) that is connected to the first sprockets 64A is driven, the chains 64C travel. The chains 64C travel at the same speed as the peripheral speed of the image recording drum 52. Further, the timings are made to match such that the sheets P that are transferred from the image recording drum 52 are received at the respective grippers 64D.

The back tension applying mechanism 66 applies back tension to the sheet P that is conveyed while the leading end thereof is grasped by the chain gripper 64. This back tension applying mechanism 66 mainly has a first guide plate 72 that serves as a suction plate and that is disposed at the ink drying processing section 20, and a second guide plate 82 that serves as a suction plate and that is disposed at the UV irradiating processing section 22.

The first guide plate 72 is structured by a boxy plate that is hollow and has a width that corresponds to the sheet width. This first guide plate 72 has numerous suction holes (not illustrated) that are formed in the top surface, and a suction fan (not illustrated) that is disposed at the lower portion side of the first guide plate 72 and sucks air from the numerous suction holes. Further, an exhaust pipe (not illustrated), for discharging the air that has been sucked from the numerous suction holes by the suction fan, is provided at the lower portion side of the first guide plate 72.

Although not illustrated, similarly, the second guide plate 82 also is structured by a boxy plate that is hollow and has a width that corresponds to the sheet width, and has numerous suction holes that are formed in the top surface, a suction fan for sucking air from the numerous suction holes, and an exhaust pipe for discharging air.

The first guide plate 72 is disposed along the conveying path of the sheet P by the chain gripper 62 (=the traveling path of the chains). Concretely, the first guide plate 72 is disposed along the chains 64C that travel on the front half portion of the first horizontal conveying path 70A, and is disposed so as to be separated by a predetermined distance from the chains 64C. Further, the second guide plate 82 is disposed along the chains 64C that travel on the rear half portion of the first horizontal conveying path 70A, and is disposed so as to be separated by a predetermined distance from the chains 64C. The sheet P that is conveyed by the chain gripper 64 is conveyed while the reverse surface (the surface at the side at which the image is not recorded) of the sheet P slidingly contacts the top surface of the first guide plate 72 and the top surface of the second guide plate 82 (the surfaces facing the chains 64C: sliding contact surfaces).

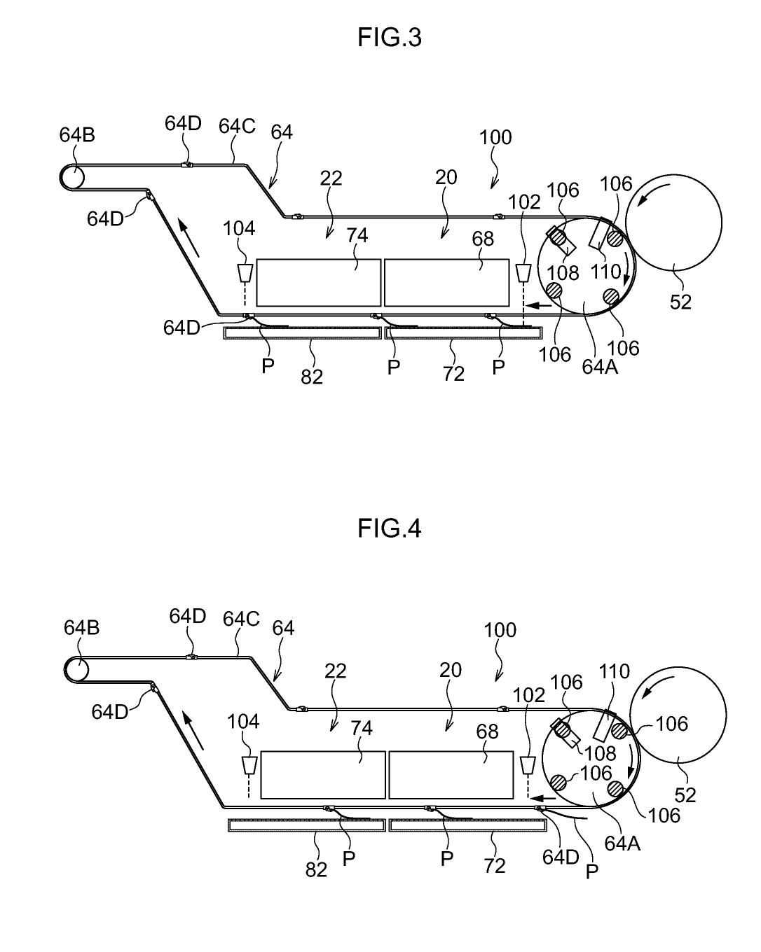

Due to air being sucked from the suction holes of the first guide plate 72, the reverse surface of the sheet P that is conveyed by the chain gripper 64 is sucked by the suction holes (see FIG. 3). Due thereto, back tension is applied to the sheet P that is conveyed by the chain gripper 64. At the second guide plate 82 as well, similarly, the reverse surface of the sheet P that is conveyed by the chain gripper 64 is sucked by the suction holes, and back tension is applied to the sheet P that is conveyed by the chain gripper 64.

As described above, the first guide plate 72 is disposed along the chains 64C that travel on the front half portion of the first horizontal conveying path 70A, and the second guide plate 82 is disposed along the chains 64C that travel on the rear half portion of the first horizontal conveying path 70A. Therefore, back tension is applied while the sheet P is being conveyed on the first horizontal conveying path 70A.

The ink drying processing unit 68 is set within the chain gripper 64 (in particular, at the front half side of the region that structures the first horizontal conveying path 70A), and carries out drying processing on the sheet P that is conveyed on the first horizontal conveying path 70A. This ink drying processing unit 68 blows hot air out onto the obverse of the sheet P that is conveyed on the first horizontal conveying path 70A, and carries out drying processing. Namely, the ink drying processing unit 68 functions as a heat source that blows hot air out onto the obverse of the sheet P. The ink drying processing unit 68 is disposed along the first horizontal conveying path 70A. The length in the sheet conveying direction and the air volume of the ink drying processing unit 68 are set in accordance with the processing capability of the ink drying processing unit 68, the conveying speed of the sheet P (=the printing speed), and the like. Namely, the length and the air volume are set such that the sheet P that has been received from the image recording section 18 can be dried while being conveyed on the first horizontal conveying path 70A. Accordingly, the length of the first horizontal conveying path 70A as well is set in consideration of the capability of this ink drying processing unit 68. The ink drying processing unit 68 is structured by a combination of IR heaters or the like, fans, and hot air jetting nozzles, that are disposed at positions facing the sheet P that is conveyed by the chain gripper 64.

The hot air jetting nozzles of the ink drying processing unit 68 are structured so as to blow hot air, that has been controlled to a predetermined temperature, out toward the sheet P at a uniform air volume. The IR heaters are respectively controlled to a predetermined temperature. Moisture contained in the recording surface of the sheet P is evaporated by these hot air jetting nozzles and IR heaters, and drying processing is carried out.

The ink drying processing section 20 is structured as described above. The sheet P, that has been transferred from the image recording drum 52 of the image recording section 18, is received at the chain gripper 64. The chain gripper 64 grasps the leading end of the sheet P by the gripper 64D, and conveys the sheet P along the first guide plate 72 that is planar. The sheet P that has been transferred to the chain gripper 64 is first conveyed on the first horizontal conveying path 70A. In the process of being conveyed on this first horizontal conveying path 70A, the sheet P is subjected to drying processing by the ink drying processing unit 68 that is set at the interior of the chain gripper 64. Namely, hot air is blown-out onto the obverse (the image recording surface) of the sheet P, and drying processing is carried out. At this time, the sheet P is subjected to the drying processing while back tension is applied thereto by the back tension applying mechanism 66. Due thereto, drying processing can be carried out while deformation of the sheet P is suppressed.

<UV Irradiating Processing Section>

The UV irradiating processing section 22 irradiates ultraviolet rays (UV) onto the image that was recorded by using the aqueous UV inks, and fixes the image. This UV irradiating processing section 22 is mainly structured by the chain gripper 64 that conveys the sheet P, the back tension applying mechanism 66 that applies back tension to the sheet P conveyed by the chain gripper 64, and a UV irradiating unit 74 that serves as an example of a fixing section and that irradiates ultraviolet rays onto the sheet P that is conveyed by the chain gripper 64 and cures the inks. In the present embodiment, the “drying/fixing section” is structured by the ink drying processing unit 68 that is disposed at the conveying direction upstream side of the sheet P, and the UV irradiating unit 74 that is disposed further toward the conveying direction downstream side of the sheet P than this ink drying processing unit 68.

As described above, the chain gripper 64 and the back tension applying mechanism 66 are used in common at the ink drying processing section 20 and the sheet discharging section 24 as well.

The UV irradiating unit 74 is set at the interior of the chain gripper 64 (the region that structures the rear half portion of the first horizontal conveying path 70A), and irradiates ultraviolet rays onto the obverse of the sheet P conveyed on the first horizontal conveying path 70A. This UV irradiating unit 74 is structured by plural ultraviolet ray lamps (UV lamps) that are disposed along the first horizontal conveying path 70A. Further, the UV irradiating unit 74 irradiates ultraviolet rays toward the obverse of the sheet P that is conveyed on the first horizontal conveying path 70A. There are also cases in which this UV irradiating unit 74 functions as a heat source. The conveying direction length and the UV irradiation amount of this UV irradiating unit 74 are set in accordance with the conveying speed of the sheet P (=the printing speed), and the like. Namely, the length and the irradiation amount are set such that the image can be fixed by the ultraviolet rays that are irradiated while the sheet P is being conveyed on the first horizontal conveying path 70A. Accordingly, the length of the first horizontal conveying path 70A also is set in consideration of the conveying speed of the sheet P, and the like.

The UV irradiating processing section 22 is structured as described above. The sheet P, that has been conveyed by the chain gripper 64 and subjected to drying processing at the ink drying processing section 20, is conveyed on the rear half portion of the first horizontal conveying path 70A. At the rear half portion of the first horizontal conveying path 70A, the chain gripper 64 grasps the leading end of the sheet P by the gripper 64D, and conveys the sheet P along the second guide plate 82. In this process of being conveyed on the rear half portion of the first horizontal conveying path 70A, the sheet P is subjected to UV irradiating processing by the UV irradiating unit 74 that is set at the interior of the chain gripper 64. Namely, ultraviolet rays are irradiated from the UV irradiating unit 74 toward the obverse. At this time, the sheet P is subjected to the UV irradiating processing while back tension is applied thereto by the back tension applying mechanism 66. Due thereto, UV irradiating processing can be carried out while deformation of the sheet P is suppressed.

<Sheet Discharging Section>

The sheet discharging section 24 collects the sheets P on which the series of image recording processings have been carried out. This sheet discharging section 24 is mainly structured by the chain gripper 64 that conveys the sheet P that has been UV-irradiated, and a sheet discharging stand 76 that stacks and collects the sheets P.

As described above, the chain gripper 64 is used in common at the ink drying processing section 20 and the UV irradiating processing section 22 as well. The chain gripper 64 releases the sheets P onto the sheet discharging stand 76, and stacks the sheets P on the sheet discharging stand 76.

The sheet discharging stand 76 stacks and collects the sheets P that have been released from the chain gripper 64. Sheet abutters (a front sheet abutter, a rear sheet abutter, transverse sheet abutters, or the like) are provided (not illustrated) at this sheet discharging stand 76 so that the sheets P are stacked orderly.

Further, the sheet discharging stand 76 is provided so as to be able to be raised and lowered by an unillustrated sheet discharging stand raising/lowering device. The driving of the sheet discharging stand raising/lowering device is controlled interlockingly with the increase/decrease in the sheets P that are stacked in the sheet discharging stand 76, and the sheet discharging stand raising/lowering device raises and lowers the sheet discharging stand 76 such that the sheet P, that is positioned topmost, is always positioned at a constant height.

<Structure of Jam Detecting Device>

A jam detecting device, that is provided at the ink drying processing section 20 and the UV irradiating processing section 22 of the inkjet recording device 10 of the present embodiment, is described next.

As shown in FIG. 3, a jam detecting device 100 that detects dropping-off (a jam) of the sheet P is provided at the ink drying processing section 20 and the UV irradiating processing section 22. The jam detecting device 100 has a first sensor (an In sensor) 102 that is disposed at a first detection position at a conveying direction upstream side of the sheet P by the chain gripper 64 and that detects the absence or presence of the sheet P, and a second sensor (an Out sensor) 104 that is disposed at a second detection position that is further toward the conveying direction downstream side of the sheet P than the first detection position and that detects the absence or presence of the sheet P (see FIG. 1).

In the present embodiment, the first sensor 102 is disposed at the entrance of the ink drying processing unit 68 that structures the drying/fixing section. Concretely, the first sensor 102 is disposed between the first sprockets 64A and the ink drying processing unit 68 in the conveying direction of the sheet P by the chain gripper 64. The second sensor 104 is disposed at the exit of the UV irradiating unit 74 that structures the drying/fixing section. Concretely, the second sensor 104 is provided at a position past the UV irradiating unit 74 in the conveying direction of the sheet P by the chain gripper 64.

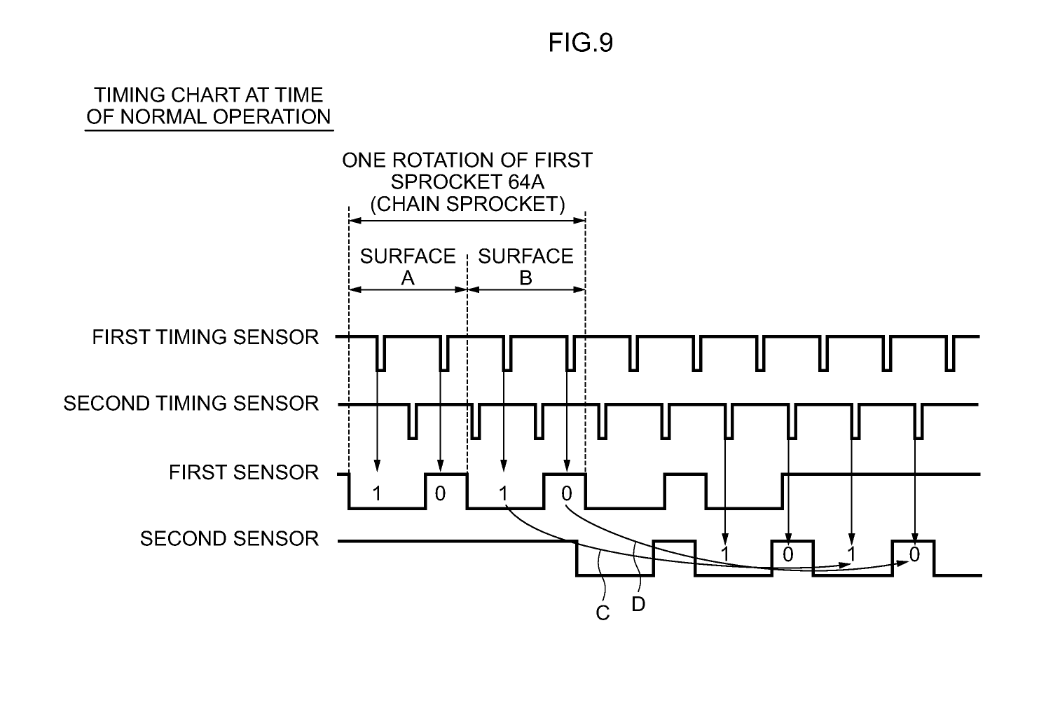

In the present embodiment, for example, non-contact-type distance sensors are used as the first sensor 102 and the second sensor 104. For example, the first sensor 102 and the second sensor 104 monitor holes (not illustrated) that are provided in the first guide plate 72 and the second guide plate 82. When the hole is blocked by the sheet P, the first sensor 102 and the second sensor 104 output signal “1” that corresponds to “there is a sheet”. Further, when the hole is not blocked by the sheet P, the first sensor 102 and the second sensor 104 output signal “0” that corresponds to “there is no sheet” (see FIG. 9).

The jam detecting device 100 has plural sensor dogs 106 that are disposed at the side surface of the first sprocket 64A that serves as an example of a rotating/supporting member that drives the chain gripper 64, so as to correspond to positions of alternately detecting a region at which there is the sheet P at the chain gripper 64 and a region at which there is no sheet P (a region between the sheets P). The plural sensor dogs 106 are fixed to the side surface of the first sprocket 64A, and rotate in the peripheral direction integrally with the first sprocket 64A.

In the present embodiment, the first sprockets 64A are substantially the same size as the image recording drum 52, and are set so as to rotate at the same cycle as the image recording drum 52. As described above, the image recording drum 52 is set so as to convey two of the sheets P by holding two of the sheets P on the peripheral surface thereof by the grippers 52A (see FIG. 1). The first sprocket 64A has four of the sensor dogs 106 at approximately 90° intervals on the circular side surface of the first sprocket 64A. In order to correspond to positions of alternately detecting a region at which there is the sheet P at the chain gripper 64 and a region at which there is no sheet P (a region between the sheets P), the four sensor dogs 106 are adjusted with respect to the positions of the grippers 64D. In other words, the four sensor dogs 106 are disposed at positions relative to the holding positions of the sheets P by the grippers 64D and positions at which the sheets P are not held between the grippers 64D.

The jam detecting device 100 has, at a position facing the first sprocket 64A, a first timing sensor (an In timing sensor) 108 that detects passage of the sensor dog 106 and determines the detection timing of the first sensor 102. Moreover, the jam detecting device 100 has, at a position facing the first sprocket 64A, a second timing sensor (an Out timing sensor) 110 that detects passage of the sensor dog 106 and determines the detection timing of the second sensor 104. At this jam detecting device 100, in order to correspond to positions of alternately detecting a region at which there is the sheet P at the chain gripper 64 and a region at which there is no sheet P (a region between the sheets P), the first timing sensor 108 and the second timing sensor 110 are disposed at positions that face the first sprocket 64A and that are synchronous with the distance between the grippers 64D of the chain gripper 64.

In the present embodiment, for example, photointerrupters that have a light emitting portion and a light receiving portion that face one another, are used as the first timing sensor 108 and the second timing sensor 110. The photointerrupter detects passage of the sensor dog 106 due to the sensor dog 106, that is formed from a blocking plate, blocking light at the time when light from the light emitting portion is received at the light receiving portion. Namely, the sensor dog 106 is detected when the sensor dog 106 enters into the detection range of the first timing sensor 108 or the second timing sensor 110 due to rotation of the first sprocket 64A.

The first timing sensor 108 and the second timing sensor 110 determine the detection timings of the first sensor 102 and the second sensor 104 so as to correspond to positions of alternately detecting a region at which there is the sheet P at the chain gripper 64 and a region at which there is no sheet P (a region between the sheets P). In other words, the jam detecting device 100 causes the first sensor 102 or the second sensor 104 to detect whether there is or is not the sheet P that is actually conveyed, when the first sensor 102 or the second sensor 104 faces a position of alternately detecting a region at which there is the sheet P and a region at which there is no sheet P (a region between the sheets P) due to movement of the chain gripper 64.

Due thereto, at the time of normal operation of the inkjet recording device 10, the first sensor 102 alternately detects “there is a sheet” and “there is no sheet”, and the second sensor 104 alternately detects “there is a sheet” and “there is no sheet”.

<Control System of Inkjet Recording Device (Jam Detecting Device)>

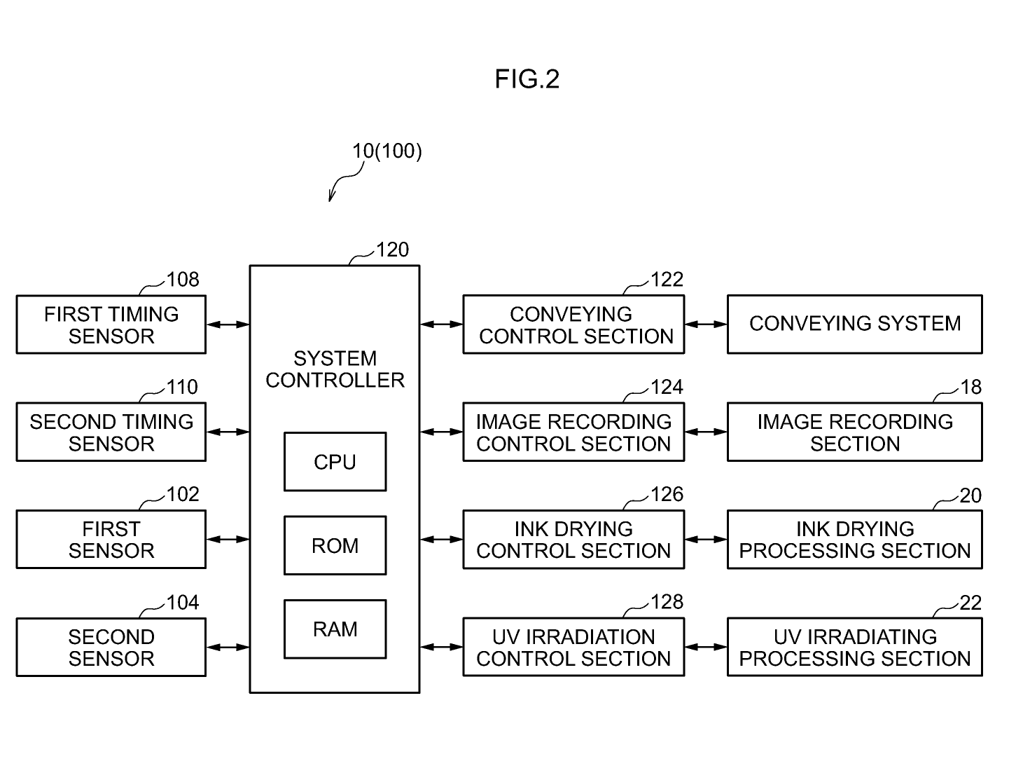

FIG. 2 is a block diagram showing the control system of the inkjet recording device 10. In FIG. 2, only portions relating to the jam detecting device 100 in the control system of the inkjet recording device 10 are illustrated. As shown in this drawing, the inkjet recording device 10 (the jam detecting device 100) has a system controller 120 that serves as a control device, a conveying control section 122, an image recording control section 124, an ink drying control section 126, a UV irradiation control section 128, and the like. Moreover, as described above, the inkjet recording device 10 (the jam detecting device 100) has the first sensor 102, the second sensor 104, the first timing sensor 108, the second timing sensor 110, and the like.

The system controller 120 functions as a control device that integratedly controls the respective sections of the inkjet recording device 10, and functions as an arithmetic unit that carries out various types of arithmetic processings. This system controller 120 has a CPU, a ROM, a RAM and the like, and operates in accordance with predetermined control programs. Control programs that this system control 120 executes, and various types of data needed for control, are stored in the ROM.

The conveying control section 122 controls the conveying system of the sheet P at the inkjet recording device 10. Namely, the conveying control section 122 controls the driving of the tape feeders 36A, the front abutter 38, and the sheet feeding drum 40 at the sheet feeding section 12, and controls the driving of the processing liquid applying drum 42 at the processing liquid applying section 14, the processing liquid drying processing drum 46 at the processing liquid drying processing section 16, and the image recording drum 52 at the image recording section 18 (see FIG. 1). Further, the conveying control section 122 controls the driving of the chain gripper 64 and the back tension applying mechanism 66 that are used in common at the ink drying processing section 20, the UV irradiating processing section 22, and the sheet discharging section 24 (see FIG. 1).

In accordance with commands from the system controller 120, the conveying control section 122 controls the conveying systems, and effects control such that the sheet P is conveyed from the sheet feeding section 12 to the sheet discharging section 24 without delay.

The image recording control section 124 controls the image recording section 18 in accordance with commands from the system controller 120. Concretely, the image recording control section 124 controls the driving of the inkjet heads 56C, 56M, 56Y, 56K such that a predetermined image is recorded on the sheet P that is conveyed by the image recording drum 52. Further, the image recording control section 124 controls the operation of the inline sensor 58 such that the recorded image is read-out (see FIG. 1).

The ink drying control section 126 controls the ink drying processing section 20 in accordance with commands from the system controller 120. Concretely, the ink drying control section 126 controls the driving of the ink drying processing unit 68 such that hot air is blown onto the sheet P that is conveyed by the chain gripper 64.

The UV irradiation control section 128 controls the UV irradiating processing section 22 in accordance with commands from the system controller 120. Concretely, the UV irradiation control section 128 controls the driving of the UV irradiating unit 74 such that ultraviolet rays are irradiated onto the sheet P that is conveyed by the chain gripper 64.

With reference to FIG. 3 as well, when the first timing sensor (the In timing sensor) 108 detects passage of the sensor dog 106 of the side surface of the first sprocket 64A, the first timing sensor 108 outputs the detection signal thereof to the system controller 120. In accordance with the detection signal of the first timing sensor 108, the system controller 120 causes the first sensor (the In sensor) 102 to detect the absence or presence of the sheet P. In the present embodiment, the positions of the four sensor dogs 106 of the side surface of the first sprocket 64A correspond to positions of alternately detecting a region at which there is the sheet P at the chain gripper 64 and a region at which there is no sheet P (a region between the sheets P). Due thereto, when the first timing sensor 108 detects passage of the sensor dog 106, due to the first sensor 102 detecting the absence or presence of the sheet P at that timing, a region at which there is the sheet P at the chain gripper 64 and a region at which there is no sheet P (a region between the sheets P) are detected alternately. Namely, when a region at which there is the sheet P at the chain gripper 64 and a region at which there is no sheet P (a region between the sheets P) pass the position facing the first sensor 102 due to movement of the chain gripper 64, whether there actually is or is not the sheet P at the respective regions is detected by the first sensor 102.

Similarly, when the second timing sensor (the Out timing sensor) 110 detects passage of the sensor dog 106 of the side surface of the first sprocket 64A, the second timing sensor 110 outputs the detection signal thereof to the system controller 120. In accordance with the detection signal of the second timing sensor 110, the system controller 120 causes the second sensor (the Out sensor) 104 to detect the absence or presence of the sheet P. Namely, when the second timing sensor 110 detects passage of the sensor dog 106, due to the second sensor 104 detecting the absence or presence of the sheet P at that timing, a region at which there is the sheet P at the chain gripper 64 and a region at which there is no sheet P (a region between the sheets P) are detected alternately. Namely, when a region at which there is the sheet P at the chain gripper 64 and a region at which there is no sheet P (a region between the sheets P) pass the position facing the second sensor 104 due to movement of the chain gripper 64, whether there actually is or is not the sheet P at the respective regions is detected by the second sensor 104.

The first sensor 102 and the second sensor 104 detect the absence or presence of the sheet P that is conveyed by the chain gripper 64. More concretely, the first sensor 102 and the second sensor 104 monitor holes (not illustrated) that are provided in the first guide plate 72 and the second guide plate 82, and detect whether or not the hole is blocked by the sheet P. When the hole is blocked by the sheet P, the first sensor 102, the second sensor 104 outputs signal “1” that corresponds to “there is a sheet” to the system controller 120. Further, when the hole is not blocked by the sheet P, the first sensor 102, the second sensor 104 outputs signal “0” that corresponds to “there is no sheet” to the system controller 120 (see FIG. 9).

In the present embodiment, control is carried out such that a region at which there is the sheet P at the chain gripper 64 and a region at which there is no sheet P (a region between the sheets P) are detected alternately. Therefore, at the time of normal operation, the first sensor 102 alternately detects “there is a sheet” and “there is no sheet”, and the second sensor 104 alternately detects “there is a sheet” and “there is no sheet”. When “there is a sheet” is detected continuously at either of the first sensor 102 or the second sensor 104, the system controller 120 judges that there is a jam. Together therewith, the system controller 120 judges that there is a jam when there is inconsistency between the information relating to the absence or presence of the sheet P from the first sensor 102 and the second sensor 104. Namely, the system controller 120 functions as a judging device that judges jams.

<Operation of Jam Detecting Device>

Operation and effects of the jam detecting device 100 provided at the inkjet recording device 10 are described next.

The jam detecting device 100 has the first sensor 102 at the entrance of the ink drying processing unit 68 that structures the drying/fixing section, and has the second sensor 104 at the exit of the UV irradiating unit 74 that structures the drying/fixing section. Due thereto, it is detected whether or not the sheet P that has entered into the drying/fixing section has been discharged reliably, i.e., whether or not the information relating to the absence or presence of the sheet P from the first sensor 102 and the second sensor 104 are in accord. Further, a region of the chain gripper 64 where there is the sheet P and a region at which there is no sheet P (a region between the sheets P) are detected alternately, and it is detected whether or not the sheet P has dropped-off from the chain gripper 64.

The first sensor 102 detects the absence or presence of the sheet P at the timing when the sensor dog 106 of the first sprocket 64A passes the first timing sensor 108. Further, the second sensor 104 detects the absence or presence of the sheet P at the timing when the sensor dog 106 of the first sprocket 64A passes the second timing sensor 110. Due thereto, it can be detected whether or not the sheet P is actually being held by the chain gripper 64.

First, explanation is given of the detecting of the sheet P by the first sensor 102 that is disposed at the entrance of the ink drying processing unit 68.

As shown in FIG. 3, when passage of the sensor dog 106 is detected by the first timing sensor 108 accompanying the rotation of the first sprocket 64A, the first sensor 102 detects the absence or presence of the sheet P at that timing. At this time, the first sensor 102 corresponds to a region of the chain gripper 64 where there is the sheet P. In the example of FIG. 3, the sheet P is actually held at the corresponding region of the chain gripper 64, and signal “1” that corresponds to “there is a sheet” is outputted by the first sensor 102 to the system controller 120.

As shown in FIG. 4, when passage of the next sensor dog 106 at the rotational direction downstream side is detected by the first timing sensor 108 accompanying the rotation of the first sprocket 64A, the first sensor 102 detects the absence or presence of the sheet P at that timing. At this time, the first sensor 102 corresponds to a region of the chain gripper 64 where there is no sheet P (a region between the sheets P). Therefore, signal “0” that corresponds to “there is no sheet” is outputted by the first sensor 102 to the system controller 120. Moreover, when passage of the next sensor dog 106 at the rotational direction downstream side of the first sprocket 64A is detected by the first timing sensor 108, the detecting of the absence or presence of the sheet P by the first sensor 102 is executed repeatedly.

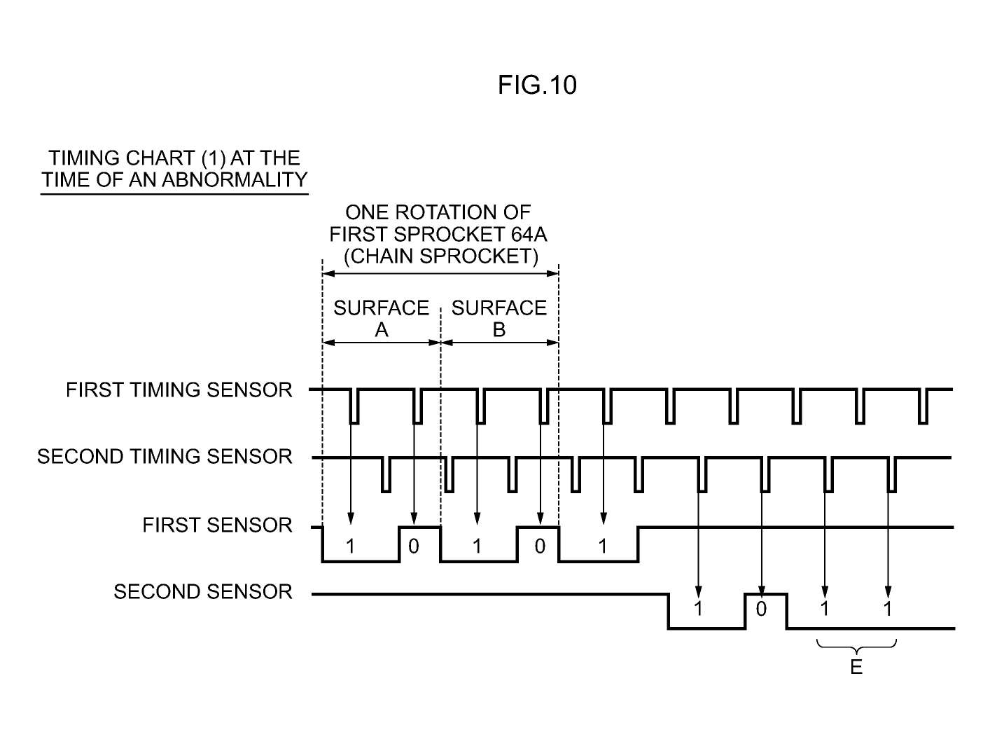

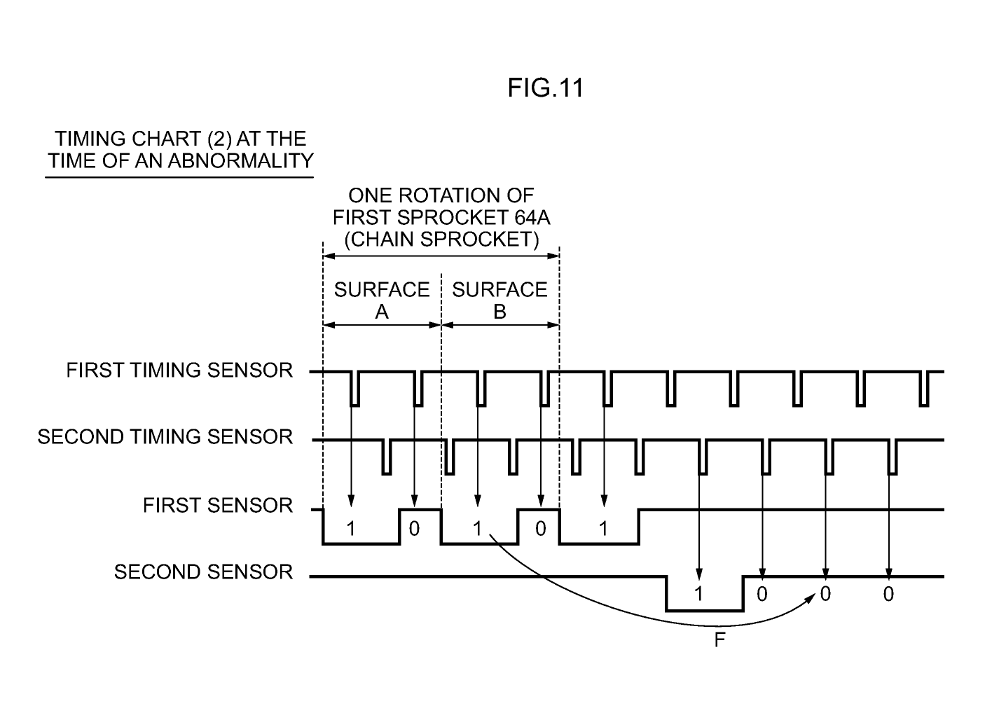

A timing chart of the jam detecting device 100 is shown in FIG. 9. As shown in FIG. 9, when a detection signal of the sensor dog 106 is outputted from the first timing sensor 108, the first sensor 102 detects the absence or presence of the sheet P at that timing. As described above, when there is the sheet P, the first sensor 102 outputs signal “1” that corresponds to “there is a sheet”, and, when there is no sheet P, the first sensor 102 outputs signal “0” that corresponds to “there is no sheet”. Note that, in FIG. 9, the four sensor dogs 106 are disposed at the first sprocket (the chain sprocket) 64A, and predetermined regions of two of the sheets P (held regions of the sheets P and regions between sheets) can be detected, and therefore, these are denoted as surface A and surface B for convenience. The same holds in FIG. 10 and FIG. 11 as well.

Detection of the sheet P by the second sensor 104 that is disposed at the exit of the UV irradiating unit 74 is described next.

As shown in FIG. 5, when passage of the sensor dog 106 is detected at the second timing sensor 110 accompanying the rotation of the first sprocket 64A, the second sensor 104 detects the absence or presence of the sheet P at that timing. At this time, the second sensor 104 corresponds to a region of the chain gripper 64 where there is the sheet P. In the example of FIG. 5, the sheet P is actually held at the corresponding region of the chain gripper 64, and signal “1” that corresponds to “there is a sheet” is outputted by the second sensor 104 to the system controller 120.

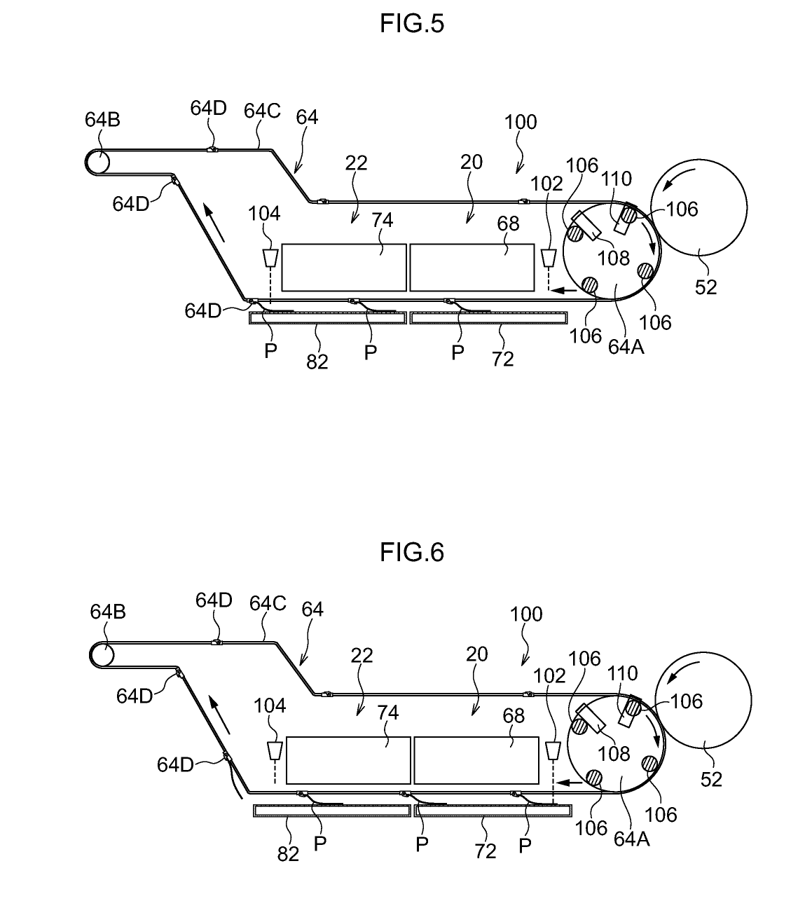

As shown in FIG. 6, when passage of the next sensor dog 106 at the rotational direction downstream side is detected by the second timing sensor 110 accompanying the rotation of the first sprocket 64A, the second sensor 104 detects the absence or presence of the sheet P at that timing. At this time, the second sensor 104 corresponds to a region of the chain gripper 64 where there is no sheet P (a region between the sheets P). Therefore, signal “0” that corresponds to “there is no sheet” is outputted by the second sensor 104 to the system controller 120. Moreover, when passage of the next sensor dog 106 at the rotational direction downstream side of the first sprocket 64A is detected by the second timing sensor 110, the detecting of the absence or presence of the sheet P by the second sensor 104 is executed repeatedly.

As shown in FIG. 9, when the detection signal is outputted by the second timing sensor 110, the second sensor 104 detects the absence or presence of the sheet P at that timing. As described above, when there is the sheet P, the second sensor 104 outputs signal “1” that corresponds to “there is a sheet”, and, when there is no sheet P, the second sensor 104 outputs signal “0” that corresponds to “there is no sheet”. The timing at which the sheet P, that is the same as the sheet P that was detected at the first sensor 102, passes the second sensor 104 (offset in the phases of the timing chart) is stored in advance in the system controller 120. Therefore, at the system controller 120, it is judged whether or not the sheet P, that is the same as the sheet P that was detected at the first sensor 102, is detected at the second sensor 104, as shown by arrows C, D in FIG. 9. In this example, as shown by arrows C, D in FIG. 9, information relating to the absence or presence of the sheet P detected at the first sensor 102 (the signal “1” for there is the sheet and the signal “0” for there is no sheet), and information relating to the absence or presence of the sheet P detected at the second sensor 104 (the signal “1” for there is the sheet and the signal “0” for there is no sheet), are in accord, and the inkjet recording device 10 is operating normally. Namely, the system controller 120 judges that the information relating to the absence or presence of the sheet P of the first sensor 102 and the second sensor 104 match.

A case in which the system controller 120 judges that there is a jam is explained next.

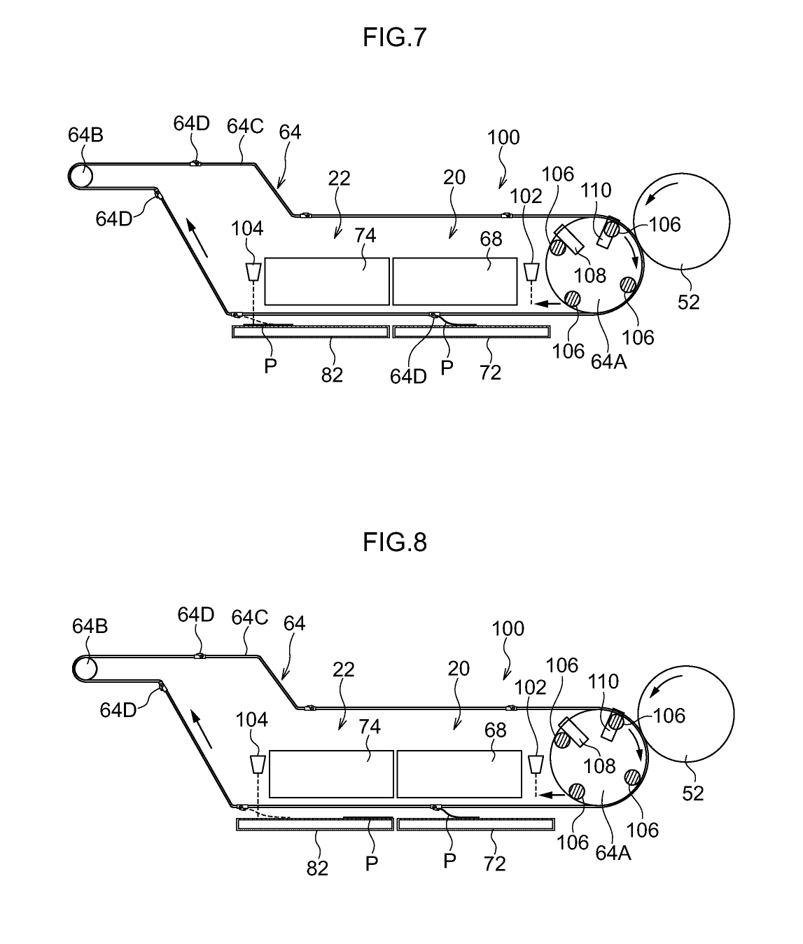

As shown in FIG. 7, when the sheet P drops-off directly beneath the second sensor 104, the sheet P stays on the second guide plate 82. Therefore, even if the chain gripper 64 moves at regions between the sheets P, the sheet P is detected by the second sensor 104, and signal “1” corresponding to “there is a sheet” is outputted.

FIG. 10 is a first example of a timing chart at the time of an abnormality, and a case in which the sheet P has dropped-off directly beneath the second sensor 104 is illustrated (timing chart (1) at the time of an abnormality). As shown in FIG. 10, in a case in which the sheet P drops-off directly beneath the second sensor 104, “1” that corresponds to “there is a sheet” is detected continuously at the second sensor 104 as shown by detection signals E in the timing chart. When signal “1” corresponding to “there is a sheet” is detected continuously at the second sensor 104, the system controller 120 judges that there is a jam.

Although not illustrated, in a case in which the sheet P drops-off directly beneath the first sensor 102, the sheet P stays on the first guide plate 72, and “there is a sheet” is detected continuously at the first sensor 102. Namely, when signal “1” corresponding to “there is a sheet” is detected continuously at the first sensor 102, the system controller 120 judges that there is a jam.

As shown in FIG. 8, in a case in which the sheet P drops-off between the first sensor 102 and the second sensor 104 in the moving direction of the chain gripper 64, the sheet P stays on the second guide plate 82 for example. Note that there are also cases in which the sheet P stays on the first guide plate 72. Therefore, even if signal “1” corresponding to “there is a sheet” is detected at the first sensor 102, the same sheet P is not detected at the second sensor 104.

FIG. 11 is a second example of a timing chart at the time of an abnormality, and a case in which the sheet P has dropped-off between the first sensor 102 and the second sensor 104 is illustrated (timing chart (2) at the time of an abnormality). As shown by arrow F in this timing chart, even though signal “1” corresponding to “there is a sheet” is detected at the first sensor 102, at the second sensor 104, signal “0” that corresponds to “there is no sheet” is detected at the timing at which that same sheet P passes. Namely, when an inconsistency arises in the information relating to the absence or presence of the sheet P from the first sensor 102 and the second sensor 104, the system controller 120 judges that there is a jam.

At this jam detecting device 100, when it is judged that there is a jam by the system controller 120, the heat sources of the ink drying processing unit 68 and the UV irradiating unit 74 are stopped in accordance with a command from the system controller 120. Due thereto, the sheet P becoming high temperature can be suppressed.

In such a jam detecting device 100, in the state in which the inkjet recording device 10 is operating normally, “there is a sheet” and “there is no sheet” are detected alternately by the first sensor 102 and the second sensor 104 (see FIG. 9).

On the other hand, in a case in which the sheet P drops-off directly beneath the first sensor 102 or the second sensor 104, “there is a sheet” is detected continuously at the first sensor 102 or the second sensor 104 (see FIG. 10). When “there is a sheet” is detected continuously at the first sensor 102 or the second sensor 104, the system controller 120 judges that there is a jam. Namely, due to “there is a sheet” being detected continuously, the jam can be detected more rapidly.

Further, in a case in which the sheet P does not drop-off directly beneath the first sensor 102 or the second sensor 104, and drops-off between the first sensor 102 and the second sensor 104, an inconsistency arises between the information relating to the absence or presence of the sheet P from the first sensor 102 and the second sensor 104 (see FIG. 11). When an inconsistency arises between the information relating to the absence or presence of the sheet P from the first sensor 102 and the second sensor 104, the system controller 120 judges that there is a jam. At this time, because the absence or presence of the sheet P is being detected alternately at the first sensor 102, the sheet P is being conveyed normally at least by an amount corresponding to the length of the sheet P from the first sensor 102, and the distance to the second sensor 104, that is the region at which the dropping-off of the sheet P has occurred, is shorter. Therefore, the jam can be detected more rapidly.

In the jam detecting device 100 of the present embodiment, the first timing sensor 108 and the second timing sensor 110 are provided at positions that face the first sprocket 64A and that are synchronous with the distance between the grippers 64D of the chain gripper 64. These timing sensors cause the first sensor 102 and the second sensor 104 to detect the absence or presence of the sheet P at timings of alternately detecting a region at which there is the sheet P at the chain gripper 64 and a region at which there is no sheet P (a region between the sheets P). Namely, whether or not the sheet P is actually being conveyed is detected by the first sensor 102 and the second sensor 104 at timings of alternately detecting a region at which there is the sheet P and a region at which there is no sheet P (a region between the sheets P), and therefore, a jam can be detected more rapidly.

Further, at the jam detecting device 100, the absence or presence of the sheet P is detected by the first sensor 102 that is disposed at the entrance of the drying/fixing section, and the absence or presence of the recording medium is detected by the second sensor 104 that is disposed at the exit of the drying/fixing section. Due thereto, a jam can be detected more rapidly even in cases in which the sheet P drops-off directly beneath the entrance and the exit of the drying/fixing section and between the entrance and the exit of the drying/fixing section.

Further, the first sprockets 64A rotate at the same cycle as the image recording drum (printing drum) 52, and the plural (four in the present embodiment) sensor dogs 106 are provided at positions, of the first sprocket 64A, which positions correspond to the holding regions of the sheets and regions between the sheets P at the image recording drum 52. Due thereto, it is easy to place the plural sensor dogs 106, and the first timing sensor 108 and the second timing sensor 110 that detect the passage of the sensor dogs 106.

Moreover, at the jam detecting device 100, when it is judged by the system controller 120 that there is a jam, the heat sources of the ink drying processing unit 68 and the UV irradiating unit 74 are stopped. Therefore, the sheet P becoming high temperature can be suppressed.

### OTHER POINTS

Although an embodiment of the present invention has been described above, the present invention is not limited in any way to the above-described embodiment, and it goes without saying that the present invention can be implemented in various forms within a scope that does not depart from the gist thereof.

At the inkjet recording device 10, the first sensor is provided at the entrance of the drying/fixing section, and the second sensor is provided at the exit of the drying/fixing section. However, the positions of the first sensor and the second sensor are not limited to these. For example, there may be a structure in which the first sensor is provided at a first detection position that is at the conveying direction upstream side of the sheet P by the conveying member, and the second sensor is provided at a second detection position that is further toward the conveying direction downstream side of the sheet P than this first detection position.

At the inkjet recording device 10, there is a structure in which the chain gripper 64 is moved by the first sprockets 64A and conveys the sheet P, and the sheet P is dried at the ink drying processing unit, and the inks on the sheet P are cured at the UV irradiating unit. However, the conveying member is not limited to a chain gripper. For example, there may be a structure in which a conveying belt, that is driven by rotating/supporting members, is used as the conveying member, and the sheets P are conveyed by the conveying belt.

The disclosure of Japanese Application No. 2013-049243 is, in its entirety, incorporated by reference into the present specification.

All publications, patent applications, and technical standards mentioned in this specification are incorporated by reference into the present specification to the same extent as if such individual publication, patent application, or technical standard was specifically and individually indicated to be incorporated by reference.

What is claimed is:

1. An image forming device comprising:
a conveying member that successively conveys recording media;
a first sensor that is provided at a first detection position, which is at a conveying direction upstream side of the recording media that is conveyed by the conveying member, and that detects absence or presence of a recording medium;
a second sensor that is provided at a second detection position, which is further toward a conveying direction downstream side of the recording media than the first detection position, and that detects absence or presence of a recording medium;
a plurality of sensor dogs that are provided at a rotating/supporting member that drives the conveying member, and that are disposed so as to correspond to positions of alternately detecting a region at which there is a recording medium at the conveying member and a region at which there is no recording medium;
a timing sensor that detects passage of the sensor dogs and determines detection timings of the first sensor and the second sensor; and
a judging device that judges that there is a jam when a recording medium is continuously detected at the first sensor or the second sensor, and that judges that there is a jam when there is inconsistency in information relating to the absence or presence of a recording medium from the first sensor and the second sensor.

2. The image forming device of claim 1, wherein:
the conveying member is a chain gripper that grasps and conveys end portions of the recording media,
the rotating/supporting member is a sprocket that moves the chain gripper, and
the timing sensor is provided at a position that faces the sprocket and that is synchronous with a distance between grippers of the chain gripper.

3. The image forming device of claim 1, wherein:
the conveying member successively conveys the recording media to a drying/fixing section that dries and fixes liquid drops that have been ejected onto the recording media, and
the first sensor is disposed at an entrance of the drying/fixing section, and the second sensor is disposed at an exit of the drying/fixing section.

4. The image forming device of claim 3, comprising a printing drum that conveys the recording media, and at which the liquid drops are ejected onto the recording media from liquid drop ejection heads, wherein the rotating/supporting member rotates at a same cycle as the printing drum, and the plurality of sensor dogs are provided at positions at the rotating/supporting member, which positions correspond to regions of holding the recording media at the printing drum and regions between the recording media.

5. The image forming device of claim 3, wherein a heat source of the drying/fixing section is stopped in a case in which it is judged by the judging device that there is a jam.
